(19) United States
(12) Patent Application Publication
(10) Pub. No.: US 2011/0218902 A1
(43) Pub. Date: Sep. 8, 2011

(54) INTELLIGENT EXECUTION FOR BROKERAGE TRADE ORDERS

(75) Inventor: Andrew Rosca, Stamford, CT (US)

(73) Assignee: NEXTROPIA LLC, Stamford, CT (US)

(21) Appl. No.: 13/025,336

(22) Filed: Feb. 11, 2011

Related U.S. Application Data
(60) Provisional application No. 61/303,623, filed on Feb. 11, 2010.

(51) Int. Cl. G06Q 40/00

(52) U.S. Cl. 705/37

(57) ABSTRACT

A method and apparatus for driving a trade via an electronic trading platform are provided. Traders may define trade order parameters including at least one monitored parameter and at least one rule for assigned thereto. The trade orders will only be executed when current market data satisfies the at least one monitored parameter and at least one rule. Said monitored parameters are selected from a current market price, a current bid and/or ask value, volume, a Volume Weighted Average Price (VWAP), or a combination thereof. The rules are based on a number and/or volume of executed market orders, placed by other traders, during a certain time period, a time period passed since it was determined that the at least one monitored parameter satisfies the market data, or a combination thereof.

### CROSS-REFERENCE TO RELATED APPLICATIONS

This application claims the benefit of U.S. Provisional Patent Application Ser. No. 61/303,623, filed Feb. 10, 2010, which is titled “Intelligent execution for brokerage stop orders”, and the entire contents of which are incorporated herein by reference.

### FIELD OF THE INVENTION

The present invention relates generally to analyzing and executing electronic trades in a financial market, and in particular, to a method and apparatus for executing trade orders based on prior analysis of market data.

### BACKGROUND OF THE INVENTION

When effecting transactions concerning different financial instruments, such as stocks, futures, options, bonds, commodities, other types of securities, etc., within a financial market, brokers strictly follow trade orders provided to them by traders or investors. In other words, a broker acts as an intermediary between a trader or investor and the financial market for the purchase and sale of financial instruments. Historically, traders provided trade orders to their brokers over telephone or other communication means, e.g. fax or e-mail. Today, the Internet development has led to the creation of different electronic trading platforms (ETP) which allow traders to quickly instruct their brokers in real-time mode. In general, such electronic trading platforms represent computer systems that can be used to place trade orders for financial instruments with brokers over a network. These platforms allow electronic trading to be carried out by traders remotely from any location and thereby are in contrast to traditional floor trading and telephone-based trading.

Among different trade orders provided to brokers, such as market orders or limit orders, a special place is assigned to stop orders or stop-loss orders. In a stop order, a trade will be carried out once a financial instrument a trader wants to buy or sell reaches a specified price. This specified price is also known as a stop price. The stop order is used by traders to control the loss that they might have or to lock in a profit on the financial instrument, or to acquire said instrument only if it reaches a particular price. They may issue the stop order to their brokers to automatically sell (buy) the financial instrument if the price of financial instrument would fall down (increase) to a particular price. Thus, generally speaking there are two types of stop orders, namely “sell top orders” and “buy stop orders”.

A sell stop order is an instruction to sell at the best available market price after the price goes below the stop price. For example, if a trader holds a stock currently valued at $50 and is worried that the value may drop, the trader can place a sell stop order at $40. If the share price drops to $40 or below, the broker sells the stock at the next available market price.

A buy stop order is typically used to limit losses. For example, if a trader sells a stock short hoping for the stock price to go down so the trader can return the borrowed shares at a lower price, the trader may use the buy stop order to protect against losses if the price goes too high.

Generally, traders commonly use stop orders entering a situation where they are unable to monitor financial market for an extended period. Stop orders can not be considered a 100% guarantee for traders of getting the desired exit profit. For instance, if a stock gaps down, the trader's sell stop order will be triggered (or filled) at a market price that could be significantly lower than it is expected.

In addition, the disadvantage of sell stop orders is that stop orders are executed immediately by ETPs when any trade occurs below or above the specified stop price within the market. This results in the problem of unintentional execution for stop orders due to various manual input errors. For instance, consider a stock with symbol ABC whose trade price is $52.00 and for which Trader A placed a stop order at $50.00. Suppose that another Trader B accidentally placed an order to sell the shares he or she owned at $5.20 instead of $52.00, and that order gets executed. The order entered by Trader A will get executed immediately in the ETP because the most recent market price of stock ABC ($5.20) is much lower than Trader A's stop price at $50.00. Even though this is an accidental, unintended trade and all subsequent trades will be at $52.00, it is recorded by the stock exchange at $5.20 and the order with the stop price at $50.00 will also get executed immediately in the ETP. The intention of the trader who placed the stop order however was to only have it execute if the general price for the stock ABC is at or below $50.00.

A similar problem may occur when no trading takes place for a certain period of time resulting in gaps. Traditionally, each gap is characterized by a jump of market prices, e.g. an “opening gap”, which occurs at the opening of trading at a market. Assume a trader places a sell stop order for a stock he or she owns with a stop price at $50. The last market price for such stock for a one day was at the level of $70, however the next day the market may open with the new price of $40 per share. In this event, the stop order will be immediately triggered by the ETP, however opening prices could be unreasonably beyond the “general trend”, and therefore they could be unintentional.

### SUMMARY

The following presents a simplified summary of one or more embodiments in order to provide a basic understanding to the reader of such embodiments. This summary is not an extensive overview of all contemplated embodiments, and it does not identify key/critical elements of the invention or delineate the scope of the invention. Its sole purpose is to present some concepts disclosed herein in a simplified form as a prelude to the more detailed description that is presented later.

In accordance with one or more embodiments and the corresponding disclosure thereof, various aspects are described herein in connection with execution of trade orders via an electronic trading platform. By uniquely analyzing prior market data, the described technique provides traders with the ability to automatically execute trade orders when a number of preset monitored parameters and rules are satisfied, thereby preventing from executing the orders in unintentional situations at financial markets, such as short time drops or spikes.

According to one aspect, a method of driving a trade via an electronic trading platform is provided. The method comprises specifying trade order parameters including at least one monitored parameter and at least one rule for the at least one monitored parameter; receiving market data from at least one market data source; comparing the received market data with the trade order parameters; and if the received market data satisfy the trade order parameters, placing the order to the electronic trading platform for execution.

According to another aspect, an apparatus for driving a trade via an electronic trading platform is provided. The apparatus comprises at least one processor configured to: specify trade order parameters including at least one monitored parameter and at least one rule for the at least one monitored parameter; receive market data from at least one market data source; compare the received market data with the trade order parameters; and if the received market data satisfy the trade order parameters, place the order to the electronic trading platform for execution; and a memory coupled to the at least one processor.

Yet another aspect relates to a computer-readable medium having codes stored thereon. Said instructions, when executed by a computer, cause the computer to perform the steps of: specifying trade order parameters including at least one monitored parameter and at least one rule for the at least one monitored parameter; receiving market data from at least one market data source; comparing the received market data with the trade order parameters; and if the received market data satisfy the trade order parameters, placing the order to the electronic trading platform for execution.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF DRAWINGS

The disclosed aspects will hereinafter be described in conjunction with the appended drawings, provided to illustrate and not to limit the disclosed aspects, wherein like designations denote like elements, and in which:

FIG. 1 illustrates a block diagram of a trading system according to one exemplary embodiment of the present invention;

FIG. 2 illustrates a block diagram of an electronic trading platform according to one exemplary embodiment of the present invention;

FIG. 3 illustrates a process flow chart for specifying and executing trade orders with assigned rules via the electronic trading platform according to one exemplary embodiment of the present invention;

FIG. 4A illustrates an exemplary stock chart (a market price per stock versus time) having a drop caused by unintentional execution of order placed by another trader;

FIG. 4B illustrates an exemplary stock chart representing a typical example of “normal” case at financial markets;

FIG. 5 is a screen shot from a graphical user interface for entering trade order parameters by a trader according to one exemplary embodiment of the present invention.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspects may be practiced without these specific details.

Aspects are disclosed in the following description and related drawings directed to specific embodiments. Alternate embodiments may be devised without departing from the invention scope. Additionally, well-known elements will not be described in detail or will be omitted so as not to obscure the relevant details.

The word “exemplary” is used herein to mean “serving as an example, instance, or illustration”. Any embodiment described herein as “exemplary” is not necessarily to be construed as preferred or advantageous over other embodiments Likewise, the term “embodiments” does not require that all embodiments include the discussed feature, advantage or mode of operation.

The embodiments described herein can be implemented by various means depending upon the application. For example, embodiments can be implemented in hardware, firmware, software, or a combination thereof. For a hardware implementation, embodiments can be implemented with processors, controllers, micro-controllers, microprocessors, electronic devices, other electronic units designed to perform the functions described herein, or a combination thereof. Memory can be implemented within the processor or external to the processor. As used herein, the term “memory” refers to any type of long term, short term, volatile, nonvolatile, or other storage devices and is not to be limited to any particular type of memory or number of memories, or type of media upon which memory is stored. For a firmware and/or software implementation, embodiments can be implemented with modules such as procedures, functions, and so on, that perform the functions described herein. Any machine readable medium tangibly embodying instructions can be used in implementing the embodiments described herein.

As referred herein, the term “trade order” is used to refer to an instruction of a trader for a broker to buy or to sell financial instruments, such as stocks, bonds, loans, futures, options, other derivatives, etc. to be executed via an electronic trading platform. According to the present invention, the trade order may be assigned with one or more rules that define a situation at a market when the trade order shall be treated as a market order.

The term “stop order” is used herein to refer to a trade order to buy or to sell a financial instrument, when the financial instrument price reaches or passes a specified level, known as a stop price. It should be apparent to those skilled in the art that the stop order becomes a market order when the stop price is reached. A buy stop order must be at a specified price above the current market price and a sell stop order must have a specified price below the current market price.

As referred herein, the term “market data” is quote and trade related data associated with equity, fixed-income, financial derivatives, currency, and other investment instruments. This term traditionally refers to numerical price data, reported from trading venues, such as stock exchanges, or from media or financial data providers (hereinafter also referred to as “market data sources”). Generally, market data comprise price data attached to a ticker symbol and additional trading data for a specific financial instrument.

As used herein, the term “Electronic Trading Platform” is a computer system or apparatus for real-time trading at financial markets such as stock markets or stock exchanges. The electronic trading platforms can be used by traders to place orders or for financial instruments with financial intermediaries, such as brokers, market makers or stock exchanges, over a network. According to the exemplary embodiments, the Electronic Trading Platform can be implemented as a web application so that traders may drive online trading at the Electronic Trading Platform via the Internet.

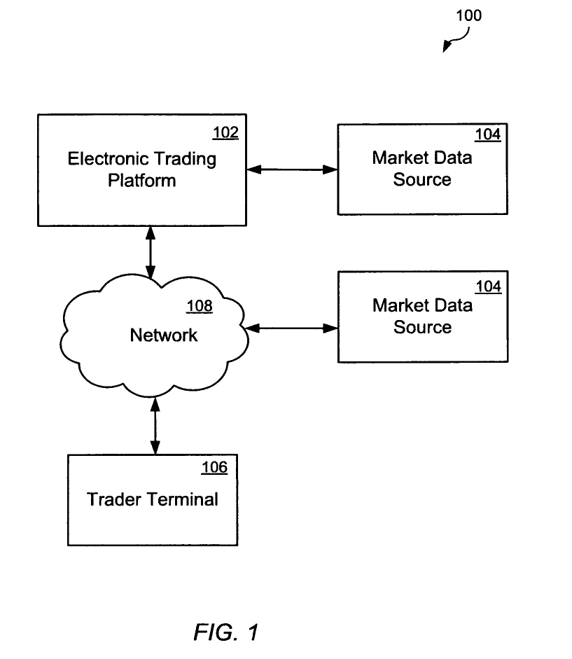

Referring now to the drawings, FIG. 1 illustrates an exemplary trading system 100. The system 100 comprises an Electronic Trading Platform (ETP) 102, market data sources 104 and a trader terminal 106 for driving a trade. The ETP 102, the trader terminal 106, and at least one market data source 104 are all connected via a network 108, such as the Internet. As shown in FIG. 1, other market data sources 104 can directly transmit market data to the ETP 102, or in some instances can be incorporated within the ETP 102. Although there are only two market data sources 104 in FIG. 1, those who are skilled in the art should understand that any number of such sources can be provided.

The preferred embodiment of the present invention is implemented in a client-server environment, as shown herein. The Internet is one example of client-server environment. However, any other appropriate type of client-server environment, such as an intranet, a wireless network, a telephone network, etc., may also be used. The present invention is not limited to the client-server model and could be implemented using any other appropriate model.

As used herein, the term “trader terminal” refers to a computer, a mobile device, a handheld cellular phone, user equipment, a portable communication device, a portable computing device, a personal digital assistant (PDA), or some other electronic device with the ability to receive and transmit data via a cord or cordless network.

In some embodiments, the trader terminal 106 may be provided with the ability to browse and/or interact with websites or web portals in the Internet, allowing traders to receive market data, and/or drive online trading at the ETP 102 according to the present invention.

According to other exemplary embodiments, the trader terminal 106 can be provided with a software or application program which allows communication with the ETP 102 and the market data sources 104 according to the present invention.

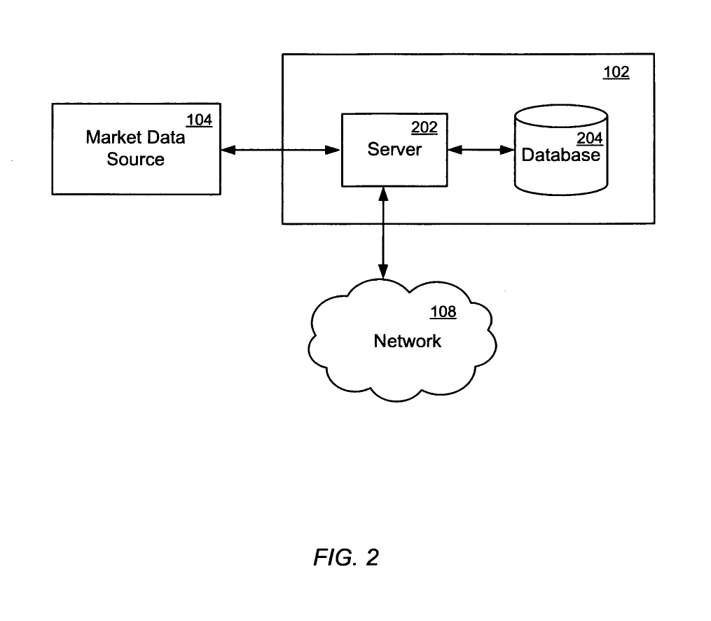

FIG. 2 illustrates an exemplary implementation of the ETP 102. The ETP 102 includes a server 202 and a database 204. The server 202 provides the connection to the network 108. Pursuant to the exemplary embodiment, the server 202 is connected to the database 204 for reading and writing data therein. The database 204 stores market data, trader data, trading data, financial data, etc. The server 202 can be implemented as hardware having software or an application installed therein for driving trades by traders including transmitting market data, placing orders, transmitting information on execution of orders, etc. The server 202 is configured to communicate with the trader terminal 106 and the market data sources 104 (directly or via the network 108).

In one embodiment, the server 202 hosts a web site, and the trader terminal 106 has a web browser installed thereon to browse the web site for trading at the ETP 102, and reviewing market data. The trader terminal 106 may also receive market data from any of the market data sources 104. For example, real-time market prices for a specific stock may be read by the trader from the remote market data source 104, while quantity of stocks currently held by the trader may be read from the web site. Therefore, the trader may compare market data from different sources, and adjust a trade strategy by visiting the web site.

According to another embodiment, the server 202 has software installed thereon to enable traders to access market data and drive trading in real-time. For example, the server 202 may comprise a gateway for traders to buy or sell financial instruments or manage their portfolio. In this case, the trade terminal 106 may have software installed thereon for accessing the server 202, comparing market data from one or more market data providers, and driving trades.

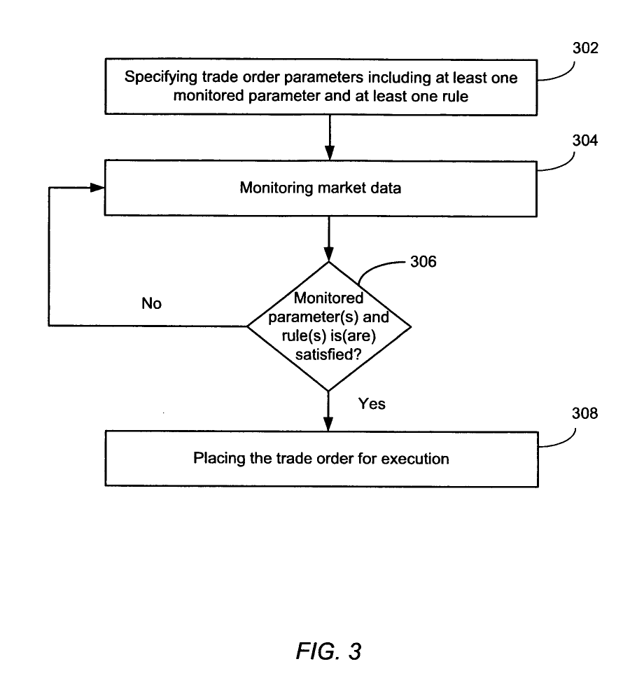

FIG. 3 illustrates a process flow chart for specifying and executing trade orders via the electronic trading platform.

At block 302, a trader specifies trade order parameters , such as a financial instrument to buy or to sell, quantity of financial instruments, an order type (a market order, a limit order, a stop order, a trailing stop order, or alike). The trade order parameters also comprise at least one monitored parameter and at least one rule for the monitored parameter. Such trade order parameters can be entered by the trader in the trader terminal 106 and processed by it and/or delivered to the ETP 102 for further processing.

As used herein, the term “rule” relates to an instruction of a trader specifying specific conditions of a financial market when a trade order shall be executed via the ETP. The specific conditions of the financial market may be based on number of factors such as: current bid or ask values, a Volume Weighted Average Price (VWAP), a number and/or volume of other orders (placed by other traders) related to the same or another financial instrument that were executed during a certain period of time and/or at or below a specified price (stop price), time passed since the last order related to the same financial instrument was executed at the ETP at or below (above) a specified price, or any combination thereof. Different examples of assigned rules are provided below.

At block 304, the trader is provided with current market data. More particularly, the trader terminal displays in real time market data received via the network from at least one market data sources 104 and/or the ETP 102. This step can also be referred to “monitoring market data”.

At block 306, it is determined whether the rule(s) is(are) satisfied with the monitored parameter based on received market data. For example, it is determined whether a financial instrument such as stock has been traded at or below a specified price for a specified time period, or are there a specified number of other orders placed by other traders that were executed at or below the specified price, or whether the total volume of trade orders currently trading at or below a specified price is above a specified number, or whether the VWAP of the stock is at or below the specified price level during a certain time period, or a combination thereof.

According to the preferred embodiment, comparison of the current market data with the monitored parameter(s) and the rule(s) can be performed by the trader terminal. However, those skilled in the art would understand that such processing can be performed by the ETP as well, or combined.

If the monitored parameter(s) is(are) satisfied with the rule(s), at block 308, the trader terminal places the trade order at the electronic trading platform for execution. At this step, the trade order can be treated as a market order, limit order, stop order, etc. depending on an order type specified by the trader at the step 302.

According to one exemplary embodiment, the trader may be notified that the trade order is executed. Such notification can be sent from the ETP 102 to the trader terminal 106 as an e-mail, SMS message, or other appropriate message to inform the trader.

If the preset monitored parameter(s) is(are) not satisfied with the rule(s), the trader terminal keeps monitoring the market data, i.e. the process returns to the block 304.

Below are provided several detailed examples of the process shown in the FIG. 3.

Assume a trader possesses a number of financial instruments such as stocks and would like to sell them depending on current conditions of the financial market. One example of such conditions is a drop of a market price for the stocks below a certain limit for a sufficient period of time. The intention of the trader is to sell stocks only when there is a “true” drop of a market price, rather than an accidental short time drop caused by execution of unintentional order with an unreasonably low price placed by another trader.

In light of the trader's purpose, at the block 302, the trader specifies trade order parameters such as an order type (in this case, “to sell”), a stock name, quantity of stocks to trade, and specifies that the order shall be treated as a market order as soon as it is placed at the ETP.

The trader also specifies one or more desirable monitored parameters and one or more rules for the monitored parameters. In the given example, the trader may wish to choose a stop price value as a monitored parameter. As a rule the trader may define a time period that the monitored parameter shall be satisfied. In other words, the trader indicates that the trade order shall be placed for execution at the ETP as soon as the market price for the stocks is at or below the stop price for the defined period of time.

As soon as the trader specifies the trade order parameters, the trader terminal monitors market data (block 304) and determines whether the monitored parameter(s) are satisfying the rule(s) based on current market data (block 306), i.e. it is determined whether the market price for the stocks drops to the level of stop price and kept at or below this level for the specified time period. If both rules are satisfied, the trader terminal submits the trade order to the ETP for execution (308), and may instruct the ETP to treat the trade order, e.g., as a market order. Thus, if an accidental short time drop occurs at the financial market, the trade order will not be executed, thereby protecting the trader from unintentional losses.

Another example is that the trader may specify a VWAP value as a monitored parameter. The VWAP (Volume Weighted Average Price) is a ratio of value traded for a financial instrument to total volume traded over a particular time period. The VWAP, generally, smoothes out a market price curve and eliminates short term fluctuations caused by accidental or abnormal orders to some extent (because the “prevailing” price does not drop much or at all if it is weighted by volume).

The trader may specify a period of time which the VWAP shall be calculated for as a rule for the monitored parameter (i.e. the VWAP value). Having specified a trade order with assigned said monitored parameter and rule, the trader terminal analyzes the market data, and places the trade order when the monitored parameter is satisfied to the rule only. In this particular example, the trader would not incur an unintended loss, if an accidental short time drop occurs at the financial market, as the trade order will not be executed by the ETP because the VWAP value would not change significantly in the event of a single order that temporarily drops the trading price.

Yet another example of trading may relate to the trader selection of a stop price as a monitored parameter, and a number and/or volume of orders (placed by other traders) that were executed at or below the stop price, as a rule. As soon as the monitored parameter is satisfied with the rule, i.e. when a “true” drop of market prices occurs, the trader terminal places the trade order for further execution.

Above are given illustrative examples of assigning different monitored parameters and rules to intelligently execute/trigger trade orders. It is understood that other possible monitored parameters and rules could be applied for any type of trade orders.

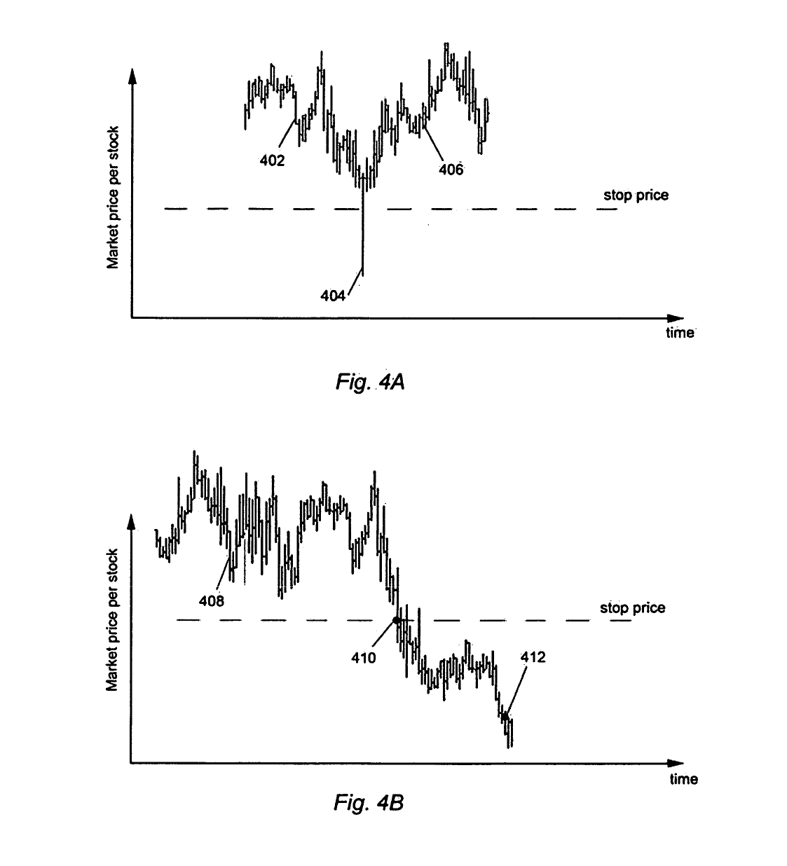

FIGS. 4A and 4B illustrate bar charts relative to a market price per stock versus time for two different situations which can occur at financial markets.

Each bar shown in these drawings represents all market prices for a financial instrument traded at a financial market during a certain period of time. The top of the vertical line indicates the highest price, while the bottom represents the lowest price. Typical time periods examples are 1 minute, 5 minutes, 15 minutes, 30 minutes, 1 hour, 1 day, 1 week, etc. Relative to the context of the present invention, and with reference to FIGS. 4A and 4B, any period of time can be chosen.

FIG. 4A represents one particular case of an accidental short time drop in market prices caused by an erroneously inputted price for an order placed by another trader. At first, a general trend weakly changes and is above a stop price defined by the trader for the trade order. This part of the trend is denoted as 402. In that event, the trader terminal 106 merely monitors market data from different market sources. Further, the trend rapidly drops (part 404) below the stop price as soon as another trader accidentally or unintentionally entered a market order with an unreasonably low price. The trader terminal 106 then analyzes the market data during a certain period of time by comparing the current market data with at least one monitored parameter and at least one rule assigned to the at least one monitored parameter. Said monitored parameters and rules can be specified by the trader as stated above and be related to time passed since the last order was executed at the ETP at or below a stop price, a number and/or volume of orders executed at or below a stop price, a VWAP, a current bid or ask values, etc., or any combination thereof. As can be seen from FIG. 4A, the accidental drop 404 represents a “spike” as the only unintentionally entered market order is executed, and thereafter the market price quickly returns back to the limits above the stop price (406). As a result, the trader terminal 106 determines that there is no compliance between the rule(s) and the market data, and therefore, does not instruct the ETP 102 to execute the order to prevent losses.

FIG. 4B is a typical example of “normal” case at financial markets, when a long time drop takes place. The general trend 408 firstly monotonically decreases to the point corresponding to the stop price. After the trend passes the level of the price stop (410), the trader terminal 106 begins analyzing rightness of the pass. As stated above, such analysis is based on the comparison of the prior and/or current market data with the at least one monitored parameter and at least one rule assigned thereto, during a certain period of time. In this case, the trader terminal 106 determines that said at least one monitored parameter and at least one rule are satisfied, and therefore, instructs the ETP 102 to execute the order (412).

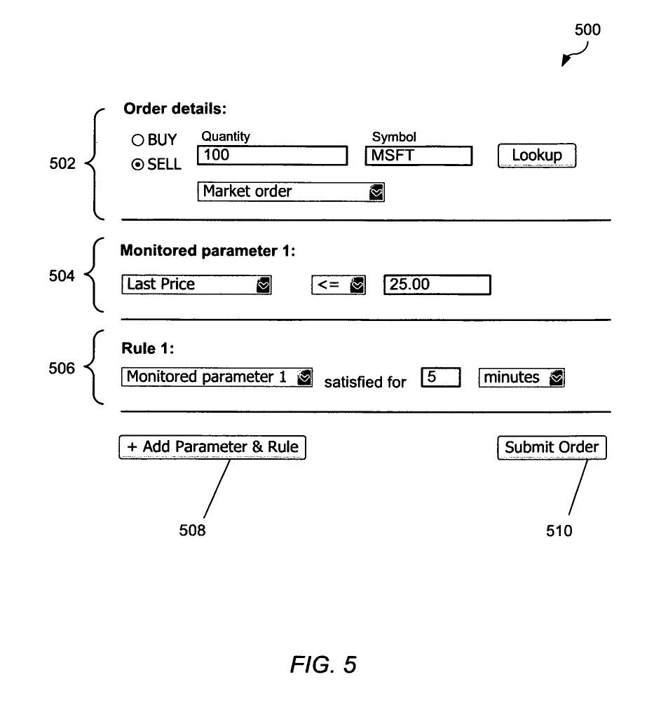

FIG. 5 is a screen shot from a graphical user interface 500 for entering (specifying) trade order parameters by a trader according to one exemplary embodiment of the present invention. Such graphical user interface can be provided or displayed to the trader via the trader terminal 106.

In the shown example, the trader is provided with the ability to specify trade order details (502), namely: an order type (e.g. “to sell” or “to buy”), a financial instrument (by inputting its symbol, e.g., “MSFT”) and its quantity (e.g., 100 units), and an order type that shall be placed and executed at the ETP (e.g. a “market” order). The graphical user interface may also include a button (clickable target, hyperlink, etc.) “Look up” to search and/or review details of a specific financial instrument.

The graphical user interface comprises one or more sections for specifying the monitored parameters and rules for the trade order. Specifically, in the example shown in FIG. 5A, there are two of such sections (502, 504). The trader may set a monitored parameter (504) to define that the last market price for the financial instrument shall reach the point ‘25.00’ or below. This monitored parameter can be considered as a “stop price”. The trader may also set a rule (506) for the monitored parameter to specify that the monitored parameter shall be satisfied for a certain period of time, e.g., at least 5 minutes starting from the moment when a market price reaches the stop price indicated in the monitored parameter section.

The graphical user interface 500 may also include a button 508 to add another monitored parameter and rule. Those skilled in the art would understand that there could be set any number of monitored parameters and rules. The graphical user interface 500 may also include a button 510 for submitting the trade order. As soon as the trader submits the trade order parameters, the trader terminal 106 starts analyzing the current market data to reveal a match with the set monitored parameter(s) and rule(s). When the monitored parameter(s) and rule(s) are satisfied with the current market data, i.e. according to the given example, the market price for the financial instrument “MSFT” felt down and kept below the specified level of “25.00” for at least 5 minutes, the trader terminal 106 instructs the electronic trading platform 102 to execute the trade order as a market order.

Although FIG. 5 and the corresponding description relate to one particular example for specifying trade order parameters including the monitored parameters and rules, it should be understood that a similar graphic interface could be used for specifying any other parameters and rules.

Those of skill in the art would understand that any of the various illustrative logical blocks, modules, processors, means, and algorithm steps described in connection with the aspects disclosed herein may be implemented as electronic hardware (for example, a digital implementation, an analog implementation, or a combination of said two, which may be designed using source coding or some other technique), various forms of program or design code incorporating instructions (which may be referred to herein, for convenience, as “software”), or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. Those who are skilled in the art may implement the described functionality in varying ways for each particular application, but such implementation decisions should not be interpreted as causing a departure from the scope of the present disclosure.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In one or more exemplary embodiments, the functions described may be implemented in hardware, software, firmware, or any combination thereof. If implemented in software, the functions may be stored on or transmitted over as one or more instructions or code on a computer-readable medium. A computer-readable medium includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web server, website, server, or other remote source using a cored or cordless network, then the cored or cordless network is included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable medium. It should be appreciated that a computer-readable medium may be implemented in any suitable computer-program product.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

1. A method of driving a trade via an electronic trading platform, comprising:
specifying trade order parameters including at least one monitored parameter and at least one rule for the at least one monitored parameter;
receiving market data from at least one market data source;
comparing the received market data with the trade order parameters; and
if the received market data satisfy the trade order parameters, placing the order to the electronic trading platform for execution.

2. The method of claim 1, wherein the at least one monitored parameter is based on one or more market data parameters including but not limited to: a current market price, a volume, a bid price, an ask price.

3. The method of claim 2, wherein the at least one monitored parameter is a Volume Weighted Average Price (VWAP).

4. The method of claim 1, wherein the order is a sell (buy) stop order, and wherein the at least one monitored parameter is a stop price.

5. The method of claim 1, wherein the at least one rule is based on a number and/or volume of executed market orders, placed by other traders, during a certain time period.

6. The method of claim 1, wherein the at least one rule is based on a time period passed since it was determined that the at least one monitored parameter satisfies the market data.

7. An apparatus for driving a trade via an electronic trading platform, comprising:
at least one processor configured to:
specify trade order parameters including at least one monitored parameter and at least one rule for the at least one monitored parameter;
receive market data from at least one market data source;
compare the received market data with the trade order parameters; and
if the received market data satisfy the trade order parameters, place the order to the electronic trading platform for execution; and
a memory coupled to the at least one processor.

8. The apparatus of claim 7, wherein the at least one monitored parameter is based on one or more market data parameters including but not limited to: a current market price, a volume, a bid price, an ask price.

9. The apparatus of claim 8, wherein the at least one monitored parameter is a Volume Weighted Average Price (VWAP).

10. The apparatus of claim 7, wherein the order is a sell (buy) stop order, and wherein the at least one monitored parameter is a stop price.

11. The apparatus of claim 7, wherein the at least one rule is based on a number and/or volume of executed market orders, placed by other traders, during a certain time period.

12. The apparatus of claim 7, wherein the at least one rule is based on a time period passed since it was determined that the at least one monitored parameter satisfies the market data.

13. The apparatus of claim 7, wherein the apparatus is configured to communicate with the electronic trading platform over a network.

14. The apparatus of claim 7, wherein said apparatus is a part of the electronic trading platform.

15. A computer-readable medium having codes stored thereon, which, when executed by a computer, cause the computer to perform the steps of claim 1.
